(19) United States
(12) Patent Application Publication
(10) Pub. No.: US 2009/0308848 A1
(43) Pub. Date: Dec. 17, 2009

(54) SOFT ALLOY LAYER FORMING APPARATUS AND SOFT ALLOY LAYER FORMING METHOD

(75) Inventors: Yutaka ISHIWATA, Zushi-shi (JP); Kazuo AOYAMA, Tokyo (JP); Nobuaki ENDOU, Yokosuka-Shi (JP); Kiyotaka TANAKA, Sagamihara-shi (JP); Hitoshi KATAYAMA, Yokohama-shi (JP)

Correspondence Address: OBLON, SPIVAK, MCCLELLAND MAIER & NEUSTADT, L.L.P., 1940 DUKE STREET, ALEXANDRIA, VA, 22314, US

(73) Assignee: KABUSHIKI KAISHA TOSHIBA, Tokyo (JP)

(21) Appl. No.: 12/471,795

(22) Filed: May 26, 2009

(30) Foreign Application Priority Data
May 27, 2008 (JP) 2008-137366
Apr. 15, 2009 (JP) 2009-099021

(51) Int. Cl. B23K 9/04

(52) U.S. Cl. 219/76.14

(57) ABSTRACT

A soft alloy layer forming apparatus (10) includes a base metal support part (20) rotationally supporting a base metal (40) with a center axis (42) of an inner periphery of the base metal (40) being a rotation axis, and an arc generating unit (30) movable in a direction of the rotation axis of the inner periphery of the base metal (40), fixed at a predetermined distance from the inner peripheral face (41) of the base metal (40), and generating an arc (31) between itself and the base metal (40). While rotating the base metal (40) and maintaining the distance constant between the arc generating unit (30) and the inner peripheral face (41) of the base metal (40), a soft alloy member (50) is melted by the arc generating unit (30) to form a soft alloy layer (15) on the inner peripheral face (41) of the base metal (40).

### CROSS-REFERENCE TO RELATED APPLICATIONS

This application is based upon and claims the benefit of priority from the prior Japanese Patent Application No. 2008-137366, filed on May 27, 2008 and Japanese Patent Application No. 2009-099021, filed on Apr. 15, 2009; the entire contents of which are incorporated herein by reference.

### BACKGROUND OF THE INVENTION

1. Field of the Invention

The present invention relates to a soft alloy layer forming apparatus and a soft alloy layer forming method for forming a soft alloy layer related to a bearing supporting a rotor or the like and slidably contacting this rotor, and to a seal member contacting the rotor and sealing in lubricating oil or vapor, in a power generating apparatus such as a generator and a steam turbine, and particularly for forming a soft alloy layer slidably contacting a rotor.

2. Description of the Related Art

A generator, a steam turbine, or the like has a large weight and rotates at high speed, and thus the rotor thereof is normally supported by a journal bearing for a high load and high speed rotation. FIG. 21 is a view schematically showing a cross-sectional structure of a typical journal bearing 300. As shown in FIG. 21, the journal bearing 300 has base metals 301, 302 made of structural steel and divided vertically in two in a circumferential direction, and bearing metal layers 303, 304 formed by lining a bearing alloy, called a bearing metal (or white metal, babbit metal) that is typically Sn—Cu—Sb based, on sliding face sides of these base metals 301, 302 by centrifugal casting. The base metals 301, 302 are fixed together by bolts 305. The bearing metals forming the bearing metal layers 303, 304 are moderately soft and have excellent abrasion resistance, and thus are used not only in power generating apparatuses but widely in ships, vessels, and so on.

Incidentally, thermal power plants structured by combining boilers, steam turbines, generators, and so on have been operated conventionally as a base power, and thus operated in a steady state for a long period of time. However, in recent years, nuclear power plants have become the base power, and there are increasing occasions that thermal power plants are used for load adjustment. Consequently, in the thermal power plants, there are changes toward operation methods of repeating start and stop almost every day. Accordingly, the bearing metal layers 303, 304 receive cyclic thermal stresses accompanying daily start and stop. This has caused events that the bearing metal layers 303, 304 are damaged by thermal fatigue.

A bearing metal layer, generally formed by lining a bearing metal, is formed by centrifugal casting. FIG. 22A to FIG. 22E are views for describing steps of forming the bearing metal layer by the centrifugal casting. First, a plated layer 311 of Ni, Sn, or the like is provided for increasing adhesion strength of the bearing metal layer on an inner peripheral face of a base metal 310 made of structural steel having a hollow cylindrical shape, which forms a journal bearing (see FIG. 22A).

In this state, they are preheated by a heating apparatus 312 having an electric furnace or a gas burner, thereby making the plated layer 311 diffuse to the side of the base metal 310 and integrate with the base metal 310 (see FIG. 22B).

Subsequently, the bearing metal 313 in a molten state is poured into the base metal 310 (see FIG. 22C), and the base metal 310 is rotated at high speed to press the bearing metal 313 in a molten state against an inner side face of the base metal 310, thereby crushing defects such as blow holes (see FIG. 22D). Incidentally, at this moment, the plated layer 311 integrates with the bearing metal 313 in a molten state and disappears.

After the pouring of the bearing metal 313 in a molten state is finished, cooling water 314 is sprayed on an outer peripheral face of the base metal 310 to quench the base metal 310 and solidify the bearing metal 313 in a molten state, thereby forming the bearing metal layer (see FIG. 22E).

Subsequently, the inner and outer peripheral faces are finished by machining, and thereafter it is divided in two vertically. Thus, a journal bearing similar to that shown in FIG. 21 is obtained.

In the above-described journal bearing, the bearing metal 313 has a significantly larger thermal expansion coefficient as compared to the base metal 310. Accordingly, a solidification shrinkage and a thermal expansion difference of the bearing metal 313 when cooling down after the pouring often cause partial peeling of the bearing metal 313 from the base metal 310. In a portion where such peeling occurred, it is difficult for the heat generated in the bearing metal 313 to be released to the outside by thermal conduction through the base metal 310 during operation. Accordingly, the temperature increases to generate a large thermal stress, which causes the aforementioned thermal fatigue and damage. Furthermore, even when the base metal 310 is cooled by spraying the cooling water 314 after the centrifugal casting, the temperature of the bearing metal 313 cannot be lowered rapidly (cooling rate is about 1° C./sec) due to the large thermal capacity of the base metal 310, and thus there is a limit to refinement of the structure of the bearing metal 313.

In the above-described centrifugal casting, the bearing metal 313 is cast to a thickness that is twice to three times thicker than that of the bearing metal layer (6 mm to 10 mm) to be obtained finally, and is cut by machining to the thickness of the bearing metal layer to be obtained finally. Accordingly, the inner peripheral side of the bearing metal layer where a fine structure is formed due to the high cooling rate is removed by machining, thereby leaving the bearing metal 313 with a coarse structure in the bearing metal layer. This lowers mechanical strength in the bearing metal layer, and thus the aforementioned thermal fatigue and damage can occur easily.

Conventionally, as a method to prevent peeling of the bearing metal layer or increase its strength, for example, JP-A 08-135660 (KOKAI) discloses a technique to fix netted thin lines made of metal on the inner peripheral face of a base metal, and centrifugally cast a bearing metal thereafter, so as to combine the bearing metal layer with the netted thin lines. Further, for example, JP-A 09-010918 (KOKAI) discloses a technique to irradiate laser on the surface of a bearing metal layer made by centrifugal casting, and quench and solidify the layer after it is melted again, to thereby refine the structure.

However, with the above-described conventional technique to provide netted thin lines on the inner peripheral face of a base metal, it is difficult to provide the netted thin lines in the vicinity of a sliding face of the bearing metal layer that becomes an origin of the thermal fatigue and damage. Thus, an effect of preventing thermal fatigue and damage in the bearing metal cannot be expected. Furthermore, there arises a problem that the manufacturing cost increases because it requires a step of arranging and fixing the netted thin lines.

Further, with the above-described conventional technique to irradiate laser on the surface of the bearing metal layer to quench and solidify it after it is melted again, improvement in adhesion strength between the base metal and the bearing metal layer cannot be expected. Moreover, this technique requires having a laser irradiation step and a machining step after the irradiation, and thus poses a problem of increasing the manufacturing cost.

Further, properties of the bearing metal manufactured by the centrifugal casting largely depends on casting conditions and cooling conditions after casting, and thus there are problems of large dispersion in tensile strength, thermal fatigue strength, adhesion strength, and so on, and lack of reliability of the journal bearing.

### BRIEF SUMMARY OF THE INVENTION

Accordingly, an object of the present invention is to provide a soft alloy layer forming apparatus and a soft alloy layer forming method capable of forming a soft alloy layer that slidably contacts a rotor or the like and has excellent adhesion strength and thermal fatigue strength, and reducing the manufacturing cost thereof.

In the present invention, build-up welding process is employed to form a soft alloy layer of a bearing metal or the like. First, the background of employing this build-up welding process will be described.

The build-up welding process is applied as, for example, a manufacturing method of a bearing metal of a thrust bearing having a planar structure. FIG. 23A to FIG. 23D are views showing a cross section of a welded portion for describing steps of conventional build-up welding process, which is applied as the manufacturing method of a bearing metal of a thrust bearing having a planar structure.

In the build-up welding process, an arc 322 is generated between a base metal 320 and a welding torch 321 as shown in FIG. 23A, a bearing metal wire 323 is inserted in the arc 322, and a bearing metal layer 324 is built up on a surface of the base metal 320 while melting the bearing metal wire 323. Further, in this build-up welding process, the building up is repeated while the welding torch 321 or the base metal 320 is moved in a horizontal direction, thereby lining the surface of the base metal 320 with the bearing metal layer 324. Further, the thickness of the bearing metal layer 324 that can be built up by one layer is about 2 mm to 3 mm, and thus as shown in FIG. 23B, the aforementioned lining step is repeated to stack and line the bearing metal layer 324 to thereby produce the bearing metal layer with a predetermined thickness (see FIG. 23C). Then, as shown in FIG. 23D, its surface is finished by machining to complete the thrust bearing. This conventional build-up welding process can increase the solidification rate of the bearing metal as compared to the centrifugal casting, and thus the bearing metal layer 324 having excellent tensile strength and thermal fatigue strength can be manufactured. Further, by selecting appropriate build-up welding conditions, an interface reaction layer is formed on the interface between the base metal 320 and the bearing metal layer 324, and high adhesion strength can be obtained. Therefore, plating as in the conventional centrifugal casting is no longer necessary, and cost reduction becomes possible. Moreover, by moving the welding torch 321 or the base metal 320 in the horizontal direction at a constant speed, the bearing metal layer 324 with a predetermined thickness can be formed on the surface of the base metal 320 automatically, and this enables reduction in manufacturing time to 1/10 or shorter as compared to the conventional centrifugal casting.

Accordingly, the present inventors carried out an experiment of conventional build-up welding process, that is, lining a bearing metal layer on a curved face of the base metal of a journal bearing while moving the welding torch or the base metal in the horizontal direction. This resulted in higher tensile strength and adhesion strength as compared to the centrifugal casting, but it was found that there is a large dispersion in adhesion strength of the bearing metal layer as compared to a thrust bearing produced by similar build-up welding process.

Furthermore, the present inventors changed the build-up welding condition and experimentally produced the bearing metal layer by lining it on the curved surface of the base metal of the journal bearing while moving the welding torch or the base metal in the horizontal direction, evaluated the adhesion strength thereof, and checked the interface structure between the base metal and the bearing metal in detail. FIG. 24A to FIG. 24C are views schematically showing a cross section of the interface portion between the base metal 330 and the bearing metal layer 331 based on results of checking the interface structure between the base metal 330 and the bearing metal layer 331.

As a result of checking the interface structure between the base metal 330 and the bearing metal layer 331, when the welding current for build-up welding is too low, an interface reaction layer was not observed on the interface between the base metal 330 and the bearing metal layer 331, and the adhesion strength thereof was small (see FIG. 24A). On the other hand, when the welding current is too high, an interface reaction layer 332 with a large thickness was formed on the interface between the base metal 330 and the bearing metal layer 331, and in this case the adhesion strength was small (see FIG. 24B). Further, when welding was performed with an appropriate welding current, the interface reaction layer 332 partially having a small thickness was formed evenly, which exhibited high strength (see FIG. 24C). It was also found that the thickness of the interface reaction layer 332 on the interface between the base metal 330 and the bearing metal layer 331 becomes uneven because the above-described interface reaction layer has a thin and even thickness on a flat surface like that of the thrust bearing, and the distance between the welding torch and the base metal changes slightly on an arc face like that of the journal bearing. It was further found that there is a good correlation between the unevenness of the interface reaction layer 332 and the adhesion strength.

FIG. 25 is a view schematically showing a cross section of the interface between the base metal 330 and the bearing metal layer 331 based on results of observing the interface structure between the base metal 330 and the bearing metal layer 331 with a scanning electron microscope. As a result of observing and analyzing the interface structure between the base metal 330 and the bearing metal layer 331 with the scanning electron microscope, it was found that the interface reaction layer 332 is an intermetallic compound phase mainly formed of Fe, Sn, and Sb. Furthermore, a thin segregation layer 333 constituted mainly of Cu was observed on the bearing metal layer 331 side of the interface reaction layer 332. Specifically, iron as a component of the base metal 330 and Sn, Sb as components of the bearing metal layer 331 form the interface reaction layer 332 on the interface between the base metal 330 and the bearing metal layer 331, and it was clear that the bearing metal layer 331 has high adhesion strength due to this reaction. On the other hand, it was clear that Cu as an alloy constituent of the bearing metal layer 331 was segregated between the interface reaction layer 332 and the bearing metal layer 331 because it does not form an alloy or intermetallic compound phase with Fe, and this decreases the adhesion strength of the bearing metal layer 331.

Therefore, for the bearing metal layer to obtain high adhesion strength stably, it is important to control the aforementioned interface reaction layer to an appropriate thickness, but it is difficult to keep a welding distance (distance between the welding torch and the base metal) constant in the build-up welding on an arc face like that of the journal bearing, unlike a flat surface like that of the thrust bearing. The present inventors thought that this causes the unevenness of the thickness of the interface reaction layer formed on the interface between the base metal and the bearing metal layer. Accordingly, the present inventors conceived that the high adhesion strength can be obtained stably by controlling the thickness of the interface reaction layer, formed on the interface between the base metal and the bearing metal layer, to come within an appropriate range in the build-up welding on an arc face like that of the journal bearing, and thus came to create the present invention.

According to an aspect of the present invention, there is provided a soft alloy layer forming apparatus forming a soft alloy layer, constituted of a soft alloy and slidably contacting a rotor, on an inner peripheral face of a base metal that is an arc face by build-up welding process, the apparatus including a base metal support part rotationally supporting the base metal with a center axis of an inner periphery of the base metal being a rotation axis, and an arc generating unit movable in an axial direction of the rotation axis, fixed at a predetermined distance from the inner peripheral face of the base metal, and generating an arc between itself and the base metal, in which while rotating the base metal by the base metal support part and maintaining the predetermined distance constant between the arc generating unit and the inner peripheral face of the base metal, a soft alloy member constituted of a soft alloy is melted by the arc generated by the arc generating unit to thereby form a soft alloy layer on the inner peripheral face of the base metal.

According to an aspect of the present invention, there is also provided a soft alloy layer forming method of forming a soft alloy layer, constituted of a soft alloy and slidably contacting a rotor, on an inner peripheral face of a base metal that is an arc face by build-up welding process, the method including rotationally supporting the base metal with a center axis of an inner periphery of the base metal being a rotation axis, and while rotating the base metal and maintaining a predetermined distance constant between an arc generating unit movable in an axial direction of the rotation axis and the inner peripheral face of the base metal, forming a soft alloy layer on the inner peripheral face of the base metal by melting a soft alloy member constituted of a soft alloy by an arc generated between the arc generating unit and the base metal.

### BRIEF DESCRIPTION OF THE DRAWINGS

The present invention will be described with reference to the drawings, and these drawings are provided for illustrative purpose only, and not for limiting the invention in any way.

FIG. 1 is a view schematically showing a soft alloy layer forming apparatus of a first embodiment of the present invention.

FIG. 2A is a view schematically showing the soft alloy layer forming apparatus having a base metal support part with another structure of the first embodiment of the present invention.

FIG. 2B is a view schematically showing the soft alloy layer forming apparatus having the base metal support part with another structure of the first embodiment of the present invention.

FIG. 3 is a view showing a cross section of a base metal on which a soft alloy layer is formed using the soft alloy layer forming apparatus of the first embodiment of the present invention.

FIG. 4 is a view schematically showing a cross section of the interface between the base metal and the soft alloy layer.

FIG. 5 is a view schematically showing a soft alloy layer forming apparatus of a second embodiment of the present invention.

FIG. 6 is a view showing a cross section of a test piece used in a tensile test.

FIG. 7 is a view showing a cross section of a test piece used in an adhesion strength test.

FIG. 8 is a graph showing results of the tensile test.

FIG. 9 is a graph showing results of the adhesion strength test.

FIG. 10 is a view showing a cross section of a base metal on which a soft alloy layer is formed, for describing conventional build-up welding process for forming the soft alloy layer while moving an arc generating unit.

FIG. 11 is a picture of observing a cross section of the interface between a soft alloy layer and a base metal in example 2 with a scanning electron microscope (SEM).

FIG. 12 is a picture of observing a cross section of the interface between a soft alloy layer and a base metal in comparative example 1 with the scanning electron microscope (SEM).

FIG. 13 is a graph showing results of a tensile test and an adhesion strength test.

FIG. 14 is a picture of observing a cross section of a soft alloy layer with the scanning electron microscope (SEM).

FIG. 15 is a picture of observing a cross section of the soft alloy layer with the scanning electron microscope (SEM).

FIG. 16 is a chart showing a change over time of the average value of temperature changes of a soft alloy layer.

FIG. 17 is a picture of observing a cross section of the soft alloy layer with the scanning electron microscope (SEM).

FIG. 18 is a picture of observing a cross section of the soft alloy layer in example 2 having no cooling unit, such as a cooling gas jetting unit and a base metal cooling unit, with the scanning electron microscope (SEM).

FIG. 19 is a chart showing a change over time of the average value of temperature changes of the soft alloy layer in example 2.

FIG. 20 is a chart showing results of a tensile test and an adhesion strength test.

FIG. 21 is a view schematically showing a cross-sectional structure of a typical journal bearing.

FIG. 22A is a view for describing a step of forming a bearing metal layer by centrifugal casting.

FIG. 22B is a view for describing a step of forming the bearing metal layer by centrifugal casting.

FIG. 22C is a view for describing a step of forming the bearing metal layer by centrifugal casting.

FIG. 22D is a view for describing a step of forming the bearing metal layer by centrifugal casting.

FIG. 22E is a view for describing a step of forming the bearing metal layer by centrifugal casting.

FIG. 23A is a view showing a cross section of a welded portion for describing a step of conventional build-up welding process, which is applied as a manufacturing method of a bearing metal of a thrust bearing having a planar structure.

FIG. 23B is a view showing the cross section of the welded portion for describing a step of conventional build-up welding process, which is applied as the manufacturing method of the bearing metal of a thrust bearing having a planar structure.

FIG. 23C is a view showing the cross section of the welded portion for describing a step of conventional build-up welding process, which is applied as the manufacturing method of the bearing metal of a thrust bearing having a planar structure.

FIG. 23D is a view showing the cross section of the welded portion for describing a step of conventional build-up welding process, which is applied as the manufacturing method of the bearing metal of a thrust bearing having a planar structure.

FIG. 24A is a view schematically showing a cross section of an interface portion between a base metal and a bearing metal layer based on results of checking an interface structure between the base metal and the bearing metal layer.

FIG. 24B is a view schematically showing the cross section of the interface portion between the base metal and the bearing metal layer based on results of checking the interface structure between the base metal and the bearing metal layer.

FIG. 24C is a view schematically showing the cross section of the interface portion between the base metal and the bearing metal layer based on results of checking the interface structure between the base metal and the bearing metal layer.

FIG. 25 is a view schematically showing a cross section of the interface between the base metal and the bearing metal layer based on results of observing the interface structure between the base metal and the bearing metal layer with a scanning electron microscope.

### DETAILED DESCRIPTION OF THE EMBODIMENTS

Hereinafter, embodiments of the present invention will be described with reference to the drawings.

### First Embodiment

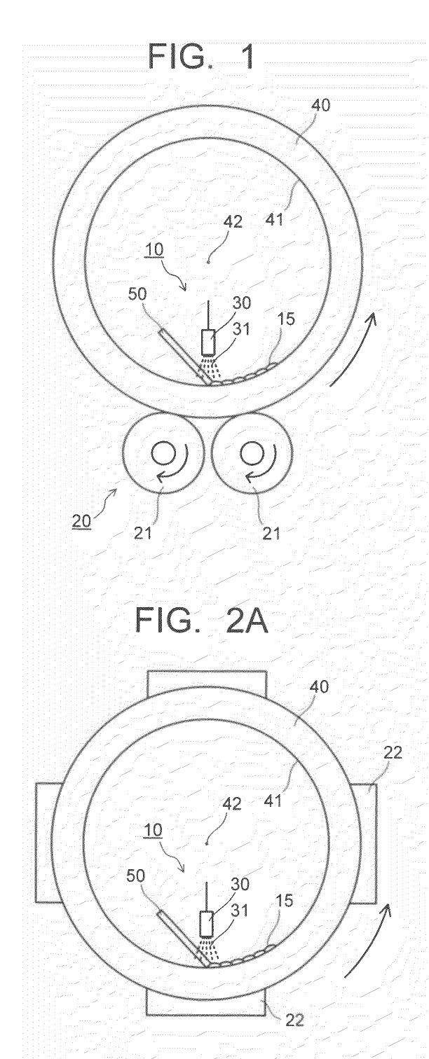

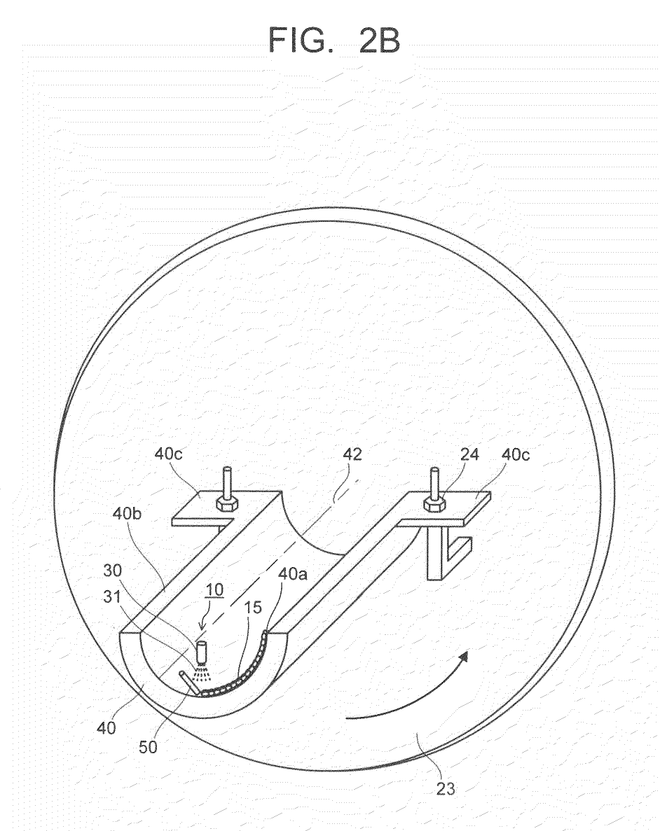

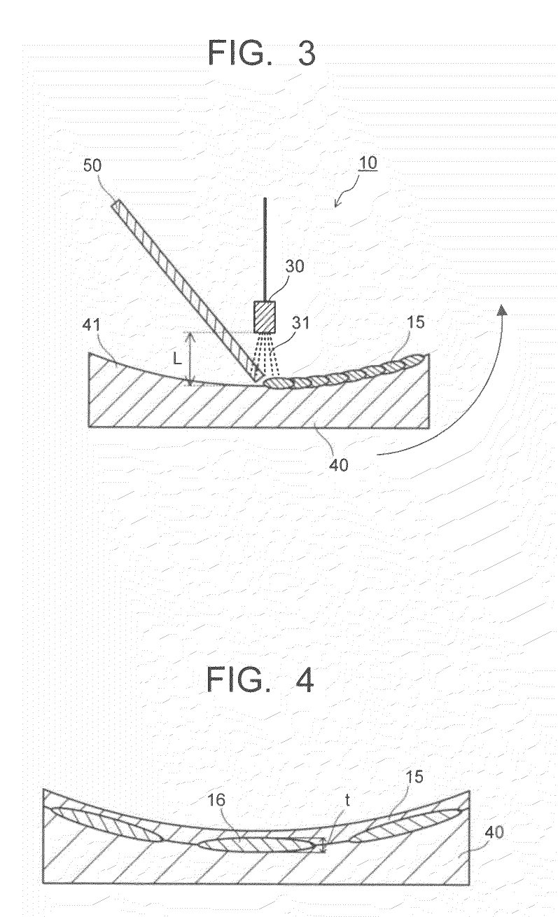

FIG. 1 is a view schematically showing a soft alloy layer forming apparatus 10 of a first embodiment of the present invention. FIG. 2A and FIG. 2B are views schematically showing the soft alloy layer forming apparatus 10 having a base metal support part 20 with another structure. FIG. 3 is a view showing a cross section of the base metal on which a soft alloy layer 15 is formed using the soft alloy layer forming apparatus 10 of the first embodiment of the present invention. FIG. 4 is a view schematically showing a cross section of the interface between the base metal 40 and the soft alloy layer 15.

The soft alloy layer forming apparatus 10 is an apparatus which forms the soft alloy layer 15 constituted of a soft alloy, which slidably contacts a rotor such as a turbine rotor for example, on an inner peripheral face 41 of the base metal 40 constituted of an arc face by build-up welding process. As shown in FIG. 1, the soft alloy layer forming apparatus 10 has a base metal support part 20 and an arc generating unit 30.

The base metal support part 20 rotationally supports the base metal 40 with a center axis 42 of an inner periphery of the base metal 40 being a rotation axis. Note that FIG. 1 shows an example that the base metal 40 is supported from a lower side by rotation rollers 21. In this structure, the base metal 40 is formed of a hollow column, and a center axis of the base metal 40 on an outer periphery matches with a center axis of the base metal 40 of an inner periphery. Thus, by rotating the rotation rollers 21 in a predetermined direction, the base metal 40 can be rotated with the inner periphery of the base metal 40 and the center axis 42 being a rotation axis.

Note that the structure of the base metal support part 20 is not limited to this structure, and for example, as shown in FIG. 2A, it may be structured that an outer peripheral face of the base metal 40 is held tightly by four support arms 22, and the support arms 22 are rotated with the center axis 42 of the inner periphery of the base metal 40 being the rotation axis. That is, the structure of the base metal support part 20 is not particularly limited, and it will suffice to have a structure in which the base metal 40 can be rotated with the center axis 42 of the inner periphery of the base metal 40 being the rotation axis.

Further, the base metal 40 may have a shape that a cylinder is divided in two, or further into three or more. Also in these structures, the base metal 40 is rotated by the base metal support part 20 with the center axis 42 of the inner periphery of the base metal 40 being the rotation axis. For example, as shown in FIG. 2, the base metal 40 having a shape of dividing the cylinder in two may be fixed by, for example, bolts 24 or the like via flange portions 40c, on a rotation disc 23 that is rotatable with the center axis 42 of the inner periphery of the base metal 40 being the rotation axis. In this structure, formation of the soft alloy layer 15 is started from one side end 40a to the other side end 40b of the base metal 40 having the shape of a cylinder divided in two. Further, when the width in a rotation axis direction is further needed in the formed soft alloy layer 15, the arc generating unit 30 is moved in the rotation axis direction by the distance corresponding to the width of the formed soft alloy layer 15, and the soft alloy layer 15 is formed again from the one side end 40a to the other side end 40b of the base metal 40. Here, the reason for starting formation of the soft alloy layer 15 from the one side end 40a of the base metal 40 when it is formed again is that the temperature of the one side end 40a of the base metal 40 is decreased.

The arc generating unit 30 generates arc 31 between itself and the base metal 40, and by this arc 31, a soft alloy member 50 formed of a soft alloy and inserted between the base metal 40 and the arc generating unit 30 is melted to form the soft alloy layer 15 on the inner peripheral face 41 of the base metal 40. The arc generating unit 30 is constituted of a welding torch or the like for example. The arc generating unit 30 is provided movably in a center axis direction of the inner periphery of the base metal 40, that is, a rotation axis direction, and is fixed having a predetermined separation distance L from the inner peripheral face 41 of the base metal 40 as shown in FIG. 3. Specifically, the separation distance L between the arc generating unit 30 and the inner peripheral face 41 of the base metal 40 is always maintained to be a constant separation distance L even when the arc generating unit 30 is moved in the rotation axis direction or the base metal 40 is rotated by the base metal support part 20.

In addition, as shown in FIG. 3, it is preferable that a tip portion of the arc generating unit 30 is disposed downward in a vertical direction having the aforementioned distance L from the lowest face of the inner peripheral face 41 of the base metal 40. Specifically, it is preferable that welding is performed on a portion that is the lowest face (lowest face in the gravitational direction) within the inner peripheral face 41 of the base metal 40, so as to prevent flowing down of a molten soft alloy and form the soft alloy layer 15 with an even thickness. Incidentally, the separation distance L can be set to the most suitable distance depending on a welding current and a constituent material or the like of the base metal 40.

Here, it is preferable that the welding current for forming a second layer and subsequent layers of the soft alloy layer 15 formed by stacking on a first layer is set smaller than the welding current for forming the first layer of the soft alloy layer 15 on the inner peripheral face 41 of the base metal 40. The soft alloy layer 15 is formed to have a predetermined thickness by forming a first layer while rotating the base metal 40 by the base metal support part 20 and weaving the arc generating unit 30 with a predetermined amplitude and frequency in a rotation axis direction which is the center axis 42 of the inner periphery of the base metal 40, and stacking and forming a second layer and further a third layer on the first layer similarly. In other words, the soft alloy layer 15 is formed of a plurality of built-up layers.

Here, as described above, adhesion strength between the first layer and the base metal 40 can be increased by setting the welding current for forming the first layer larger than the welding current for forming the second layer and subsequent layers. On the other hand, the second layer and subsequent layers can be built up by a smaller welding current as compared to that for the first layer. Further, by setting the welding current for the second layer and subsequent layers smaller, it is possible to suppress increase in temperature on the interface between the base metal 40 and the soft alloy layer 15. Thus, it is possible to suppress the growth of an interface reaction layer 16 formed on the interface between the base metal 40 and the soft alloy layer 15 as shown in FIG. 4, and prevent the structure of the soft alloy layer 15 from becoming coarse.

The soft alloy member 50 is formed of a bearing alloy called a white metal, and is generally formed of an Sn—Cu—Sb alloy mainly constituted of Sn containing Cu and Sb. A specific example of the soft alloy member 50 is a welding wire formed of the aforementioned Sn—Cu—Sb alloy. Further, as described above, from the experiment by the present inventors it was found that Cu as an alloy constituent forming the soft alloy member 50 barely affects improvement of the adhesion strength with the base metal 40, and is segregated to the interface between the interface reaction layer 16 and the soft alloy layer 15 and decreases the adhesion strength.

Accordingly, it is preferable that the Cu content of the Sn—Cu—Sb alloy for forming the soft alloy layer 15 on the inner peripheral face 41 of the base metal 40 is smaller than the Cu content of the Sn—Cu—Sb alloy for forming the second layer and subsequent layers of the soft alloy layer 15, which is formed by stacking on the first layer of the soft alloy layer 15 formed on this inner peripheral face 41. Specifically, it is preferable that the Cu content of the Sn—Cu—Sb alloy for forming the soft alloy layer 15 on the inner peripheral face of the base metal 40 is 1% to 5% by weight, more preferably 3% to 5% by weight. Here, the reason that the Cu content of the Sn—Cu—Sb alloy for forming the soft alloy layer 15 on the inner peripheral face of the base metal 40 is preferable to be in the above range is that the mechanical strength or the like of the soft alloy layer 15 decreases when the Cu content is smaller than 1% by weight, and the segregation of Cu to the interface between the interface reaction layer 16 and the soft alloy layer 15 becomes significant and decreases the adhesion strength when it is larger than 5% by weight. Further, by setting the Cu content of the Sn—Cu—Sb alloy for forming the soft alloy layer 15 on the inner peripheral face of the base metal 40 in the above range, a thin interface reaction layer 16 is formed partially and evenly on the interface between the base metal 40 and the soft alloy layer 15 as shown in FIG. 4, and the soft alloy layer 15 that is excellent in adhesion strength, tensile strength and thermal fatigue strength can be formed.

On the other hand, as the Sn—Cu—Sb alloy for forming the second layer and subsequent layers of the soft alloy layer 15, for example, it is preferable to use an alloy mainly constituted of Sn containing Sb of 8% to 10% by weight and Cu of 5% to 6% by weight. As the Sn—Cu—Sb alloy for forming the second layer and subsequent layers of the soft alloy layer 15, specifically, a white metal 2nd class (WJ2) or the like is used.

Next, a forming method of the soft alloy layer 15 with the soft alloy layer forming apparatus 10 of the first embodiment of the present invention will be described with reference to FIG. 1 to FIG. 3.

The base metal 40 is disposed on the base metal support part 20, and the base metal 40 is rotated at a predetermined rotation speed. Subsequently, the arc generating unit 30 is weaved with a predetermined amplitude (for example 5 mm to 10 mm) and frequency (1 Hz to 5 Hz) in the rotation axis direction which is the center axis 42 of the inner periphery of the base metal 40, and a predetermined voltage is applied between the arc generating unit 30 and the base metal 40 to generate the arc 31. Note that the amplitude, frequency, and so on of the arc generating unit 30 are set appropriately based on the welding conditions such as the rotation speed, the welding rate, and so on of the base metal 40. Further, the separation distance L between the arc generating unit 30 and the inner peripheral face 41 of the base metal 40 is always maintained constant.

Subsequently, the tip of the soft alloy member 50 is inserted in the arc 31 at a predetermined rate to melt the soft alloy member 50, to thereby form the soft alloy layer 15 on the inner peripheral face of the base metal 40. At this time, by one rotation of the base metal 40, the soft alloy layer 15 having a width in the rotation axis direction corresponding to the amplitude of the arc generating unit 30 is formed on the inner peripheral face 41 of the base metal 40. In the soft alloy layer 15, when a width in the rotation axis direction is further needed, the arc generating unit 30 is moved in the rotation axis direction by the distance corresponding to the amplitude of the arc generating unit 30, to further form the soft alloy layer 15 by a similar method.

Subsequently, a plurality, namely a second layer and further a third layer, of the soft alloy layer 15 are stacked by the same method on the first layer of the soft alloy layer 15 formed on the inner peripheral face of the base metal 40, to thereby form the soft alloy layer 15 with a predetermined thickness. As described above, for forming the second layer and subsequent layers of the soft alloy layer 15, the welding current may be smaller than that for forming the first layer. Further, for forming the second layer and subsequent layers of the soft alloy layer 15, it is possible to use the soft alloy member 50 having a higher Cu content than that of the soft alloy member 50 for forming the first layer. After the soft alloy layer 15 with a predetermined thickness is formed by the above method, the surface of the soft alloy layer 15 is finished by machining to obtain the final thickness.

As described above, the soft alloy layer 15 is formed on the inner peripheral face 41 of the base metal 40. Here, on the base metal 40 on which the soft alloy layer 15 is formed by the method described above, the thin interface reaction layer 16 is formed partially and evenly on the interface between the base metal 40 and the soft alloy layer 15 as shown in FIG. 4. It is preferable that the interface reaction layer 16 has a thickness t of 5 μm to 20 μm on average. The reason that the thickness t in this range is preferable is that the adhesion strength decreases when it is thicker or smaller than this range. Further, by making the thickness t of the interface reaction layer 16 to be equal to or larger than 5 μm on average, it is possible to prevent occurrence of a region in which the interface reaction layer 16 is not formed at all. Thus, the interface reaction layer 16 can be formed evenly on the interface between the base metal 40 and the soft alloy layer 15. Further, by making the thickness t of the interface reaction layer 16 to be equal to or smaller than 20 μm on average, sequential segregation of Cu to the interface between the soft alloy layer 15 and the interface reaction layer 16 can be suppressed. Thus, the interface reaction layer 16 can be formed with high adhesion strength on the inner peripheral face 41 of the base metal 40.

Note that in the soft alloy layer 15 formed as above, when part of the soft alloy layer 15 deteriorates for example, the deteriorated part is removed by cutting by machining, and the soft alloy layer 15 can be newly formed by the above-described method on the removed part. That is, the soft alloy layer 15 can be repaired partially.

Here, the base metal 40 having the soft alloy layer 15 formed by the soft alloy layer forming apparatus 10 of the first embodiment of the present invention can be used as, for example, a journal bearing supporting a steam turbine rotor and a steam turbine generator rotor via lubricating oil, a seal ring mechanism for a hydrogen cooled turbine generator, or the like. Note that the soft alloy layer forming apparatus 10 of the first embodiment of the present invention is not only used in the application to form the soft alloy layer on these portions, but can be applied widely for forming the soft alloy layer on a portion slidably contacting a rotor such as a turbine rotor. Moreover, the soft alloy layer forming apparatus 10 of the first embodiment of the present invention can be used also for, for example, forming a divided sliding surface on a lower-half inner peripheral face of a base metal like a pad-type bearing.

As described above, with the soft alloy layer forming apparatus 10 of the first embodiment of the present invention, the soft alloy layer 15 can be formed while the base metal 40 is rotated by the base metal support part 20 with the center axis 42 of the inner periphery of the base metal 40 being a rotation axis, and the separation distance L between the arc generating unit 30 and the inner peripheral face 41 of the base metal 40 is always maintained constant. Accordingly, the soft alloy layer 15 can be formed in a state that the welding conditions such as welding distance are the same, and thus for example the thickness of the interface reaction layer 16 formed on the interface between the base metal 40 and the soft alloy layer 15 can be made even and within an appropriate range. Therefore, the soft alloy layer 15 having high adhesion strength can be formed along the inner peripheral face of the base metal 40.

### Second Embodiment

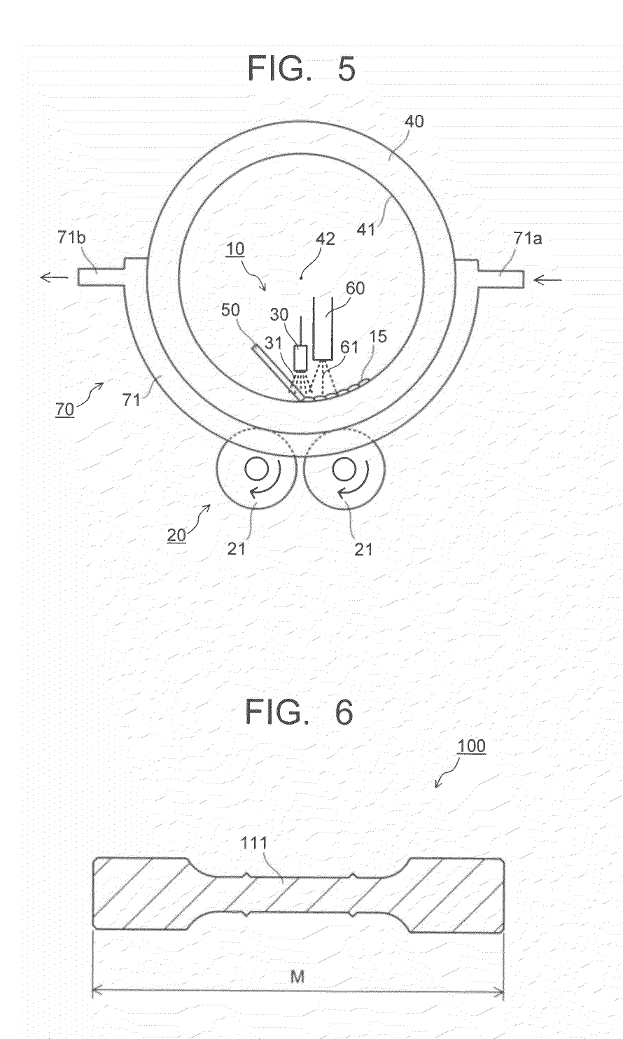

FIG. 5 is a view schematically showing a soft alloy layer forming apparatus 10 of a second embodiment of the present invention. The soft alloy layer forming apparatus 10 of the second embodiment of the present invention is structured by providing the soft alloy layer forming apparatus 10 of the first embodiment of the present invention with a cooling gas jetting unit 60 for jetting a cooling gas to the soft alloy layer 15 and a base metal cooling unit 70 for cooling an outer peripheral face of the base metal 40. Note that the same components as those in the soft alloy layer forming apparatus 10 of the first embodiment are given the same numerals, and duplicated descriptions are omitted or simplified.

As shown in FIG. 5, the soft alloy layer forming apparatus 10 includes the base metal support part 20, the arc generating unit 30, the cooling gas jetting unit 60, and the base metal cooling unit 70.

The cooling gas jetting unit 60 jets a cooling gas 61 to the soft alloy layer 15 via a jetting port such as a nozzle, and has a jetting port located at a predetermined distance from the outer peripheral face of the base metal 40. It is preferable that this cooling gas jetting unit 60 also disposed with a separation distance from the inner peripheral face of the base metal 40 being always maintained constant even when the base metal 40 is rotated, similarly to the arc generating unit 30. Accordingly, the formed soft alloy layer 15 can be cooled evenly. As the cooling gas 61 jetted from the cooling gas jetting unit 60, an inert gas of N, Ar or the like, or air is used. Among them, it is preferable to use, as the cooling gas 61, the inert gas of N, Ar or the like for example for preventing oxidation or the like of the soft alloy layer 15.

The base metal cooling unit 70 cools the outer peripheral face of the base metal 40, and as shown in FIG. 5 for example, it is constituted of a water cooled jacket 71 disposed in contact with a lower half of the outer peripheral face of the base metal 40, and so on. Note that the structure of the base metal cooling unit 70 is not limited to this, and for example, a water cooled jacket may be provided in contact with the entire outer peripheral face of the base metal 40. In addition, the water cooled jacket is provided with a supply port 71a supplying cooling water and a discharge port 71b discharging the cooling water. Further, the base metal cooling unit 70 may be constituted of, for example, a nozzle or the like to jet cooling water such as water on the outer peripheral face of the base metal 40. That is, the structure of the base metal cooling unit 70 is not particularly limited, and it will suffice to have a structure to cool the outer peripheral face of the base metal 40. Incidentally, it is preferable that the base metal cooling unit 70 is disposed with a predetermined separation distance from the outer peripheral face of the base metal 40 at a position facing the arc generating unit 30 via the base metal 40, so as to efficiently cool the soft alloy layer 15 just after being melted.

Next, a forming method of the soft alloy layer 15 with the soft alloy layer forming apparatus 10 of the second embodiment of the present invention will be described with reference to FIG. 5.

The base metal 40 is disposed on the base metal support part 20, and the base metal 40 is rotated at a predetermined rotation speed. Subsequently, the cooling gas 61 is jetted toward the inner peripheral face 41 of the base metal 40 on which the soft alloy layer 15 is formed from the cooling gas jetting unit 60. Further, the cooling water is supplied to the base metal cooling unit 70 to cool the outer peripheral face of the base metal 40.

Subsequently, the arc generating unit 30 is weaved with a predetermined amplitude (for example 5 mm to 10 mm) and frequency (1 Hz to 5 Hz) in the rotation axis direction which is the center axis 42 of the inner periphery of the base metal 40, and a predetermined voltage is applied between the arc generating unit 30 and the base metal 40 to generate the arc 31. Note that the amplitude, frequency, and so on of the arc generating unit 30 are set appropriately based on the welding conditions such as the rotation speed, the welding rate, and soon of the base metal 40. Further, the separation distance L between the arc generating unit 30 and the inner peripheral face 41 of the base metal 40 is always maintained constant.

Subsequently, the tip of the soft alloy member 50 is inserted in the arc 31 at a predetermined rate to melt the soft alloy member 50, to thereby form the soft alloy layer 15 on the inner peripheral face of the base metal 40. At this time, by one rotation of the base metal 40, the soft alloy layer 15 having a width in the rotation axis direction corresponding to the amplitude of the arc generating unit 30 is formed on the inner peripheral face 41 of the base metal 40. In the soft alloy layer 15, when a width in the rotation axis direction is further needed, the arc generating unit 30 is moved in the rotation axis direction by the distance corresponding to the amplitude of the arc generating unit 30, to further form the soft alloy layer 15 by a similar method.

Subsequently, a plurality, namely a second layer and further a third layer, of the soft alloy layer 15 are stacked by the same method on the first layer of the soft alloy layer 15 formed on the inner peripheral face of the base metal 40, to thereby form the soft alloy layer 15 with a predetermined thickness. As described above, for forming the second layer and subsequent layers of the soft alloy layer 15, the welding current may be smaller than that for forming the first layer. Further, for forming the second layer and subsequent layers of the soft alloy layer 15, it is possible to use the soft alloy member 50 having a higher Cu content than that of the soft alloy member 50 for forming the first layer. After the soft alloy layer 15 with a predetermined thickness is formed by the above method, the surface of the soft alloy layer 15 is finished by machining to obtain the final thickness.

As described above, by quenching the formed soft alloy layer 15 by the cooling gas jetting unit 60 and the base metal cooling unit 70, the formation structure of the soft alloy layer 15 can be refined. Accordingly, the tensile strength and the thermal fatigue strength can be improved, and growth of the interface reaction layer 16 and growth of the structure of the soft alloy layer 15 can be suppressed. Further, the soft alloy layer 15 can be formed with high adhesion strength on the inner peripheral face 41 of the base metal 40. Furthermore, since the soft alloy layer 15 is rapidly cooled and solidified, the formed soft alloy layer 15 will not flow and drip down even when, for example, the rotation speed of the base metal 40 is increased.

Here, it is preferable that the average cooling rate of the soft alloy layer 15 is about 10° C. to 50° C./sec, and even in this range, the higher the average cooling rate, the better it is. One reason that this range of average cooling rate is preferable is that it is difficult to most suitably refine the formation structure of the soft alloy layer 15 when the average cooling rate is lower than this range, and it further leads to growth of the interface reaction layer 16. Another reason is that when the average cooling rate is higher than this range, the soft alloy layer 15 does not spread enough and is solidified in a state of poorly fitted with the base layer, and defects such as blow holes can easily occur. In addition, this average cooling rate means the speed of cooling down from the highest temperature of the soft alloy layer 15 (temperature at which it is melted by an arc, for example 450° C. for the white metal 2nd class (WJ2)) to a temperature which is equal to or lower than the solidification start temperature of the material forming the soft alloy layer 15 and at which the structural growth of the soft alloy layer 15 becomes less significant (for example 300° C. for the white metal 2nd class (WJ2)).

One example of providing the cooling gas jetting unit 60 and the base metal cooling unit 70 is presented in the above-described soft alloy layer forming apparatus 10 of the second embodiment. Note that, however, it will suffice to have at least either of the units when the soft alloy layer 15 can be cooled at the aforementioned average cooling rate.

As described above, with the soft alloy layer forming apparatus 10 of the second embodiment of the present invention, the soft alloy layer 15 can be formed while the base metal 40 is rotated by the base metal support part 20 with the center axis 42 of the inner periphery of the base metal 40 being a rotation axis, and the separation distance L between the arc generating unit 30 and the inner peripheral face 41 of the base metal 40 is always maintained constant. Accordingly, the soft alloy layer 15 can be formed in a state that the welding conditions such as welding distance are the same, and thus for example the thickness of the interface reaction layer 16 formed on the interface between the base metal 40 and the soft alloy layer 15 can be made even and within an appropriate range. Therefore, the soft alloy layer 15 having high adhesion strength can be formed along the inner peripheral face 41 of the base metal 40.

Furthermore, in the soft alloy layer forming apparatus 10 of the second embodiment of the present invention, the cooling gas jetting unit 60 and the base metal cooling unit 70 are provided, and the formation structure of the soft alloy layer 15 can be refined by quenching the formed soft alloy layer 15. Thus, the tensile strength and the thermal fatigue strength can be improved, and growth of the interface reaction layer 16 and growth of the structure of the soft alloy layer 15 can be suppressed. This also allows to form the soft alloy layer 15 having high adhesion strength along the inner peripheral face 41 of the base metal 40.

Next, it will be described that, based on examples and comparative examples, the soft alloy layer 15 formed by the soft alloy layer forming apparatus 10 according to the present invention has excellent adhesion strength and tensile strength.

### EXAMPLE 1

In example 1, a base metal 40 made of structural steel partially imitating a journal bearing with an inner diameter of 381 mm, an outer diameter of 481 mm, and a center angle of 85° was prepared. Note that the forming method of a soft alloy layer is the same as the method described in the first embodiment, and thus the following description will be given with reference to FIG. 1.

This base metal 40 was disposed on the base metal support part 20, and the base metal was rotated at the time when building up from one end to the other end in a rotation axis direction is finished. Subsequently, the arc generating unit 30 was weaved in the rotation axis direction which is the center axis 42 of the inner periphery of the base metal 40 with an amplitude of 7 mm and a frequency of 3 Hz, and a predetermined voltage was applied between the arc generating unit 30 and the base metal 40 to generate an arc 31. In addition, the welding current at this time was 190 A. Further, the separation distance L between the arc generating unit 30 and the inner peripheral face of the base metal 40 was maintained to 7 mm constantly.

Subsequently, a soft alloy member 50 was inserted in the arc 31 at a rate of 40 cm to 50 cm/min to melt the soft alloy member, to form a soft alloy layer 15 having a width in the rotation axis direction corresponding to the amplitude of the arc generating unit 30 on the inner peripheral face 41 of the base metal 40. Here, as the soft alloy member 50, a white metal 2nd grade (WJ2) was used.

Subsequently, the arc generating unit 30 was moved in the rotation axis direction by the distance corresponding to the amplitude of the arc generating unit 30, and the soft alloy layer 15 was formed further by the same method.

Then, a plurality, namely a second layer, a third layer, and a fourth layer, of the soft alloy layer 15 were stacked by the same method on the first layer of the soft alloy layer 15 formed on the inner peripheral face 41 of the base metal 40, and thereby the soft alloy layer 15 with a thickness of 12 mm was formed.

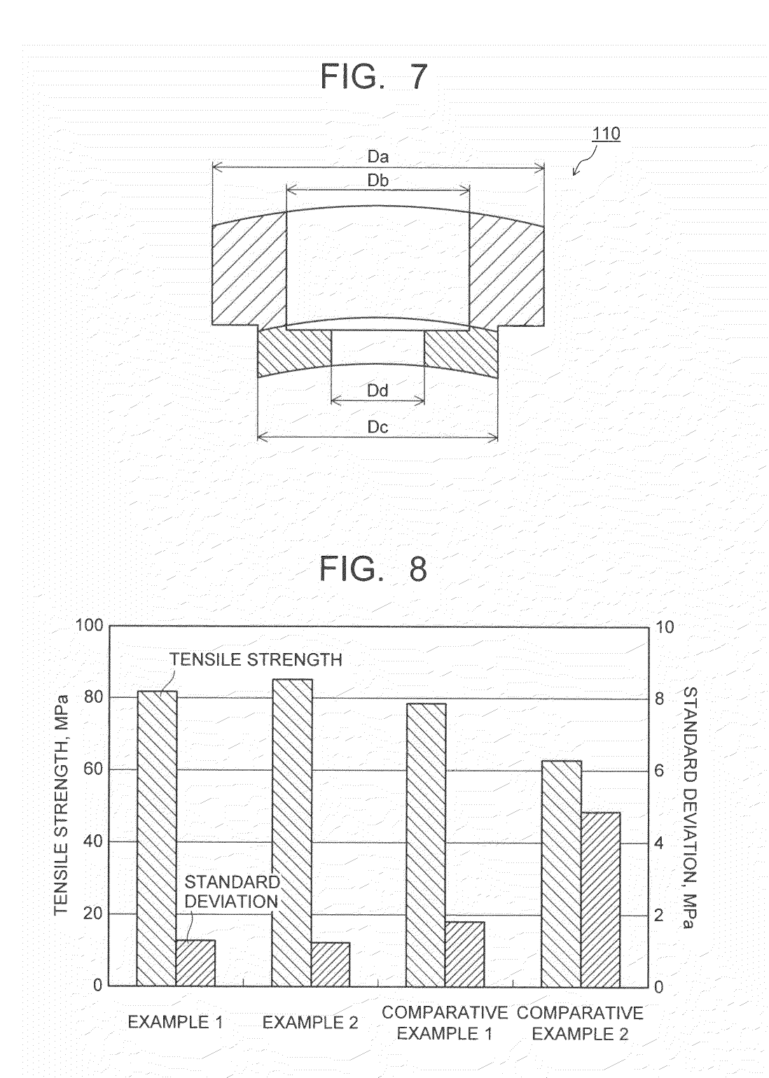

Test pieces were sampled from the base metal 40 on which the soft alloy layer 15 is produced as described above, and a tensile test and an adhesion strength test were conducted. FIG. 6 is a view showing a cross section of a test piece 100 used in the tensile test. FIG. 7 is a view showing a cross section of a test piece 110 used in the adhesion strength test.

The test piece 100 used in the tensile test shown in FIG. 6 is a cylindrical member sampled and processed in a rotation axis direction from the formed soft alloy layer 15. The test piece 100 has a parallel part 111 with a diameter of 6 mm and has a length M of 30 mm. Seven such test pieces 100 were produced, and using these test pieces 100, the tensile test was conducted at room temperature in accordance with JIS Z2241. An average value and a standard deviation were calculated from measurement results with each of the test pieces 100.

The test piece 110 used in the adhesion strength test shown in FIG. 7 is a cylindrical member that is sampled and processed including both the soft alloy layer 15 and the base metal 40. The test piece 110 is a stepped ring-shaped test piece having a portion formed of the soft alloy layer 15 with a diameter Da of 38 mm and an inner diameter Db of 24 mm, and having a portion formed of the base metal 40 with a diameter Dc of 28.82 mm and an inner diameter Dd of 12.1 mm. Seven such test pieces 110 were produced, and the adhesion strength test was conducted at room temperature in accordance with ISO 4386/2-1982 using these test pieces. An average value and a standard deviation were calculated from measurement results from each of the test pieces 110. Further, a cross section of the interface between the soft alloy layer 15 and the base metal 40 was observed with a scanning electron microscope (SEM) to measure the thicknesses of the interface reaction layer 16, and the average value thereof was obtained.

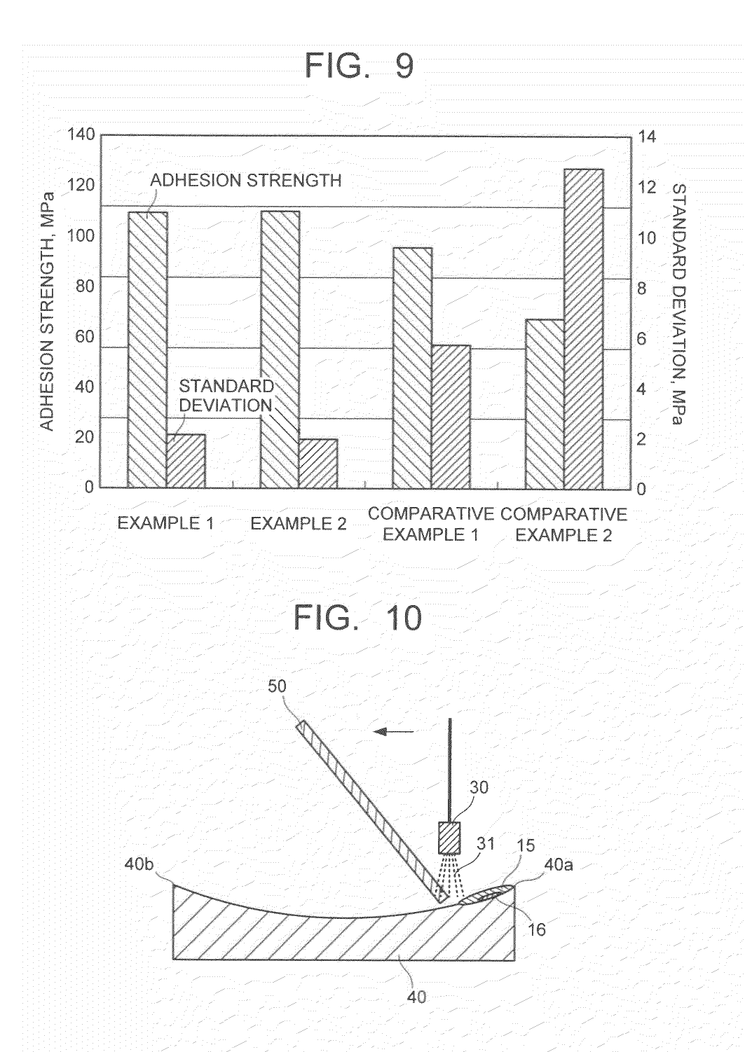

Results of the tensile test and the adhesion strength test are shown in FIG. 8 and FIG. 9. Further, the thickness of the interface reaction layer 16 was 12 μm on average.

### EXAMPLE 2

The forming method in example 2 is the same as the forming method of the soft alloy layer 15 in example 1 except that the welding current for forming the second layer and subsequent layers of the soft alloy layer 15 in example 1 is a value lower by 5% (welding current of 180 A) than the welding current for forming the soft alloy layer 15 in example 1. Further, similarly to the soft alloy layer 15 in example 1, the soft alloy layer 15 formed on the inner peripheral face 41 of the base metal 40 was formed of four layers and had a thickness of 12 mm.

Test pieces were sampled from the base metal 40 on which the soft alloy layer 15 is produced as described above, and the tensile test and the adhesion strength test were performed. Note that the shape and so on of the test pieces were the same as those in example 1. The measurement methods, the measurement conditions, and so on in the tensile test and the adhesion strength test were also the same as those in example 1. Further, a cross section of the interface between the soft alloy layer 15 and the base metal 40 was observed with the scanning electron microscope (SEM) to measure the thicknesses of the interface reaction layer 16, and the average value thereof was obtained.

Results of the tensile test and the adhesion strength test are shown in FIG. 8 and FIG. 9. Further, the thickness of the interface reaction layer 16 was 8 μm on average.

### COMPARATIVE EXAMPLE 1

In comparative example 1, similarly to conventional build-up welding forming process a soft alloy layer on the surface of a thrust bearing, the arc generating unit was weaved and moved in a predetermined direction, without rotating the base metal, so as to form the soft alloy layer. FIG. 10 is a view showing a cross section of the base metal 40 on which the soft alloy layer 15 is formed, for describing the conventional build-up welding process for forming the soft alloy layer 15 while moving the arc generating unit 30.

In comparative example 1, similarly to example 1, a base metal 40 made of structural steel partially imitating a journal bearing with an inner diameter of 381 mm, an outer diameter of 481 mm, and a center angle of 85° was prepared.

The arc generating unit 30 was positioned on one side end 40a of the base metal 40, and a predetermined voltage was applied between the arc generating unit 30 and the base metal 40 to generate the arc 31.

Subsequently, the arc generating unit 30 was weaved in the center axis direction of the inner periphery of the base metal 40 with an amplitude of 7 mm and a frequency of 3 Hz and was moved horizontally from one side end 40a of the base metal 40 to the other side end 40b of the base metal 40 while inserting a soft alloy member 50 in the arc 31 at a rate of 40 cm to 50 cm/min. Then the soft alloy member was melted, and the soft alloy layer 15, having a width in the center axis direction corresponding to the amplitude of the arc generating unit 30, was formed on the inner peripheral face of the base metal 40. Here, as the soft alloy member 50, a white metal 2nd class (WJ2) was used.

Subsequently, the arc generating unit 30 was moved by the distance corresponding to the amplitude of the arc generating unit 30 in the center axis direction of the inner periphery of the base metal 40, and the soft alloy layer 15 was formed further by the same method.

Subsequently, a plurality, namely a second layer, a third layer, and a fourth layer, of the soft alloy layer 15 were stacked by the same method on the first layer of the soft alloy layer 15 formed on the inner peripheral face of the base metal 40, and thereby the soft alloy layer 15 with a thickness of 12 mm was formed.

Test pieces were sampled from the base metal 40 on which the soft alloy layer 5 is produced as described above, and the tensile test and the adhesion strength test were performed. Note that the shape and so on of the test pieces were the same as those in example 1. The measurement methods, the measurement conditions, and so on in the tensile test and the adhesion strength test were also the same as those in example 1. Further, a cross section of the interface between the soft alloy layer 15 and the base metal 40 was observed with the scanning electron microscope (SEM) to measure the thicknesses of the interface reaction layer 16, and the average value thereof was obtained.

Results of the tensile test and the adhesion strength test are shown in FIG. 8 and FIG. 9. Further, the thickness of the interface reaction layer 16 was 75 μm on average.

### COMPARATIVE EXAMPLE 2

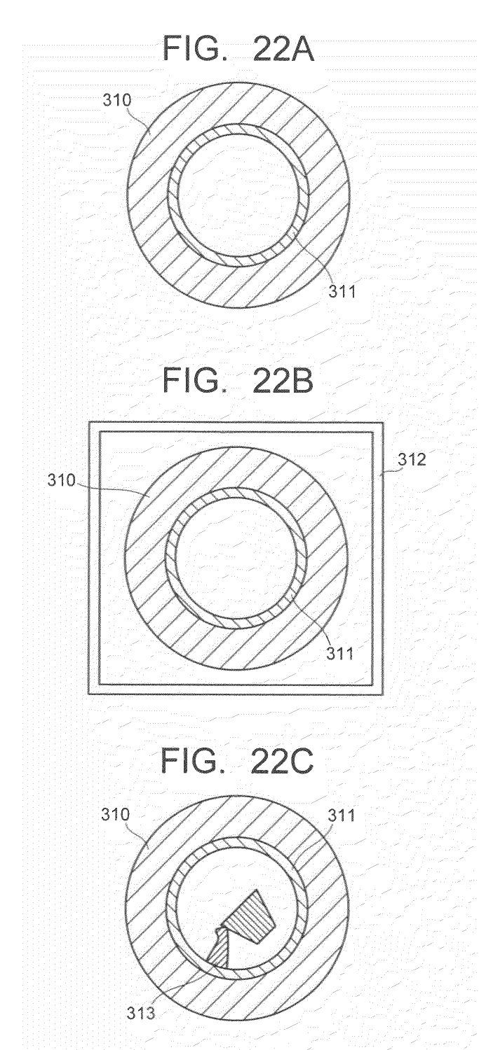

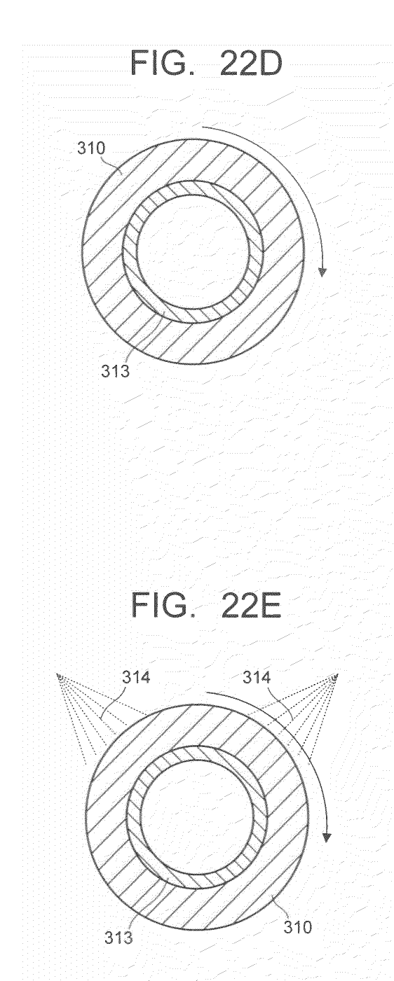

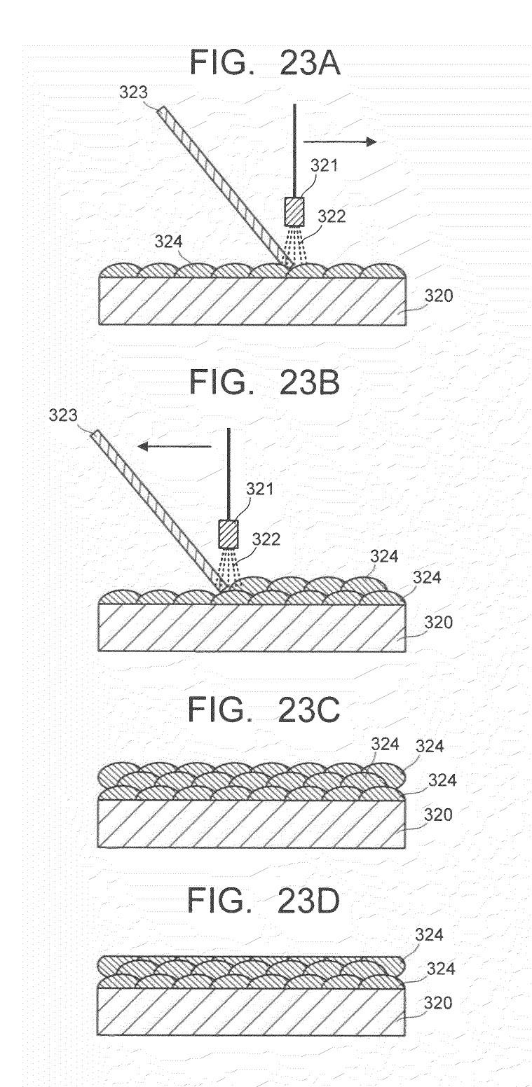

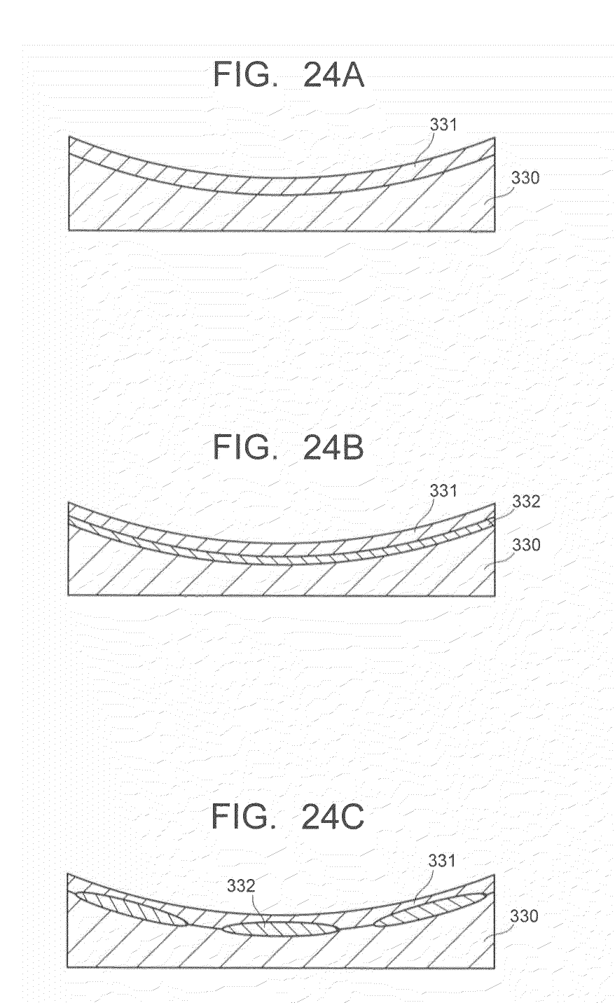

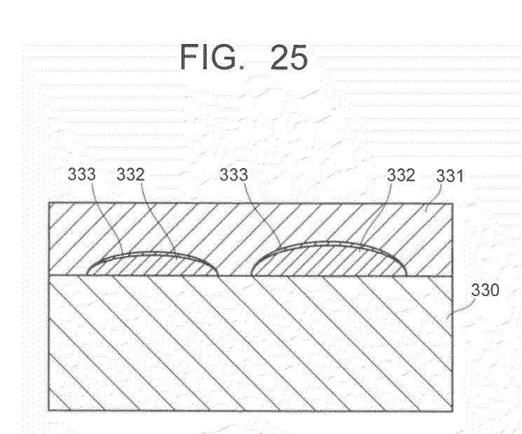

In comparative example 2, a soft alloy layer was formed by centrifugal casting. Here, a description will be given with reference to FIG. 22A to FIG. 22E.

In comparative example 2, a base metal 310 made of structural steel imitating a journal bearing with an inner diameter of 381 mm and an outer diameter of 481 mm was prepared.

First, as shown in FIG. 22A, a plated layer 311 formed of Ni was formed on an inner peripheral face of the base metal 310.

As shown in FIG. 22B, in this state, the plated layer 311 was made to diffuse to the base metal 310 side by preheating with the heating apparatus 312 using an electric furnace, and integrate with the base metal 310.

Subsequently, a bearing metal 313 that is a soft alloy formed of a white metal 2nd grade (WJ2) in a molten state was poured into the base metal 310 (see FIG. 22C), and the base metal 310 was rotated at a rotation speed of 200 rpm (see FIG. 22D). Incidentally, at this time the plated layer 311 was integrated with the soft alloy in a molten state and disappeared.

After the pouring of the soft alloy in a molten state was completed, cooling water 314 was sprayed on an outer peripheral face of the base metal 310 to quench the base metal 310 and solidify the bearing metal 313 in a molten state, and thereby the soft alloy layer was formed (FIG. 22E).

Test pieces were sampled from the base metal 310 on which the soft alloy layer is formed as described above, and the tensile test and the adhesion strength test were performed. Note that the shape and so on of the test pieces were the same as those in example 1. The measurement methods, the measurement conditions, and so on in the tensile test and the adhesion strength test were also the same as those in example 1. Further, a cross section of the interface between the soft alloy layer (bearing metal 313) and the base metal 310 was observed with the scanning electron microscope (SEM) to measure the thicknesses of the interface reaction layer, and the average value thereof was obtained.

Results of the tensile test and the adhesion strength test are shown in FIG. 8 and FIG. 9. In addition, no interface reaction layer was observed.

### (Summary of Example 1 and Example 2 and Comparative Example 1 and Comparative Example 2)

As shown in FIG. 8 and FIG. 9, the soft alloy layers formed by the build-up welding process in example 1 and example 2 and comparative example 1 had both higher tensile strength and higher adhesion strength, and further had lower standard deviations, as compared to the soft alloy layer formed by the centrifugal casting in comparative example 2. Thus, it was found that a soft alloy layer having more excellent in tensile strength and adhesion strength and having smaller dispersions in these strength can be obtained when the build-up welding process is employed, as compared to when the centrifugal casting is employed. Further, among those employing the build-up welding process, the soft alloy layers formed while maintaining the welding distance constant by rotating the base metal as in example 1 and example 2 had higher tensile strength and adhesion strength and further had smaller standard deviations, as compared to the soft alloy layer formed without maintaining the welding distance constant as in comparative example 1. Particularly, this tendency was significant in the adhesion strength and its standard deviation.

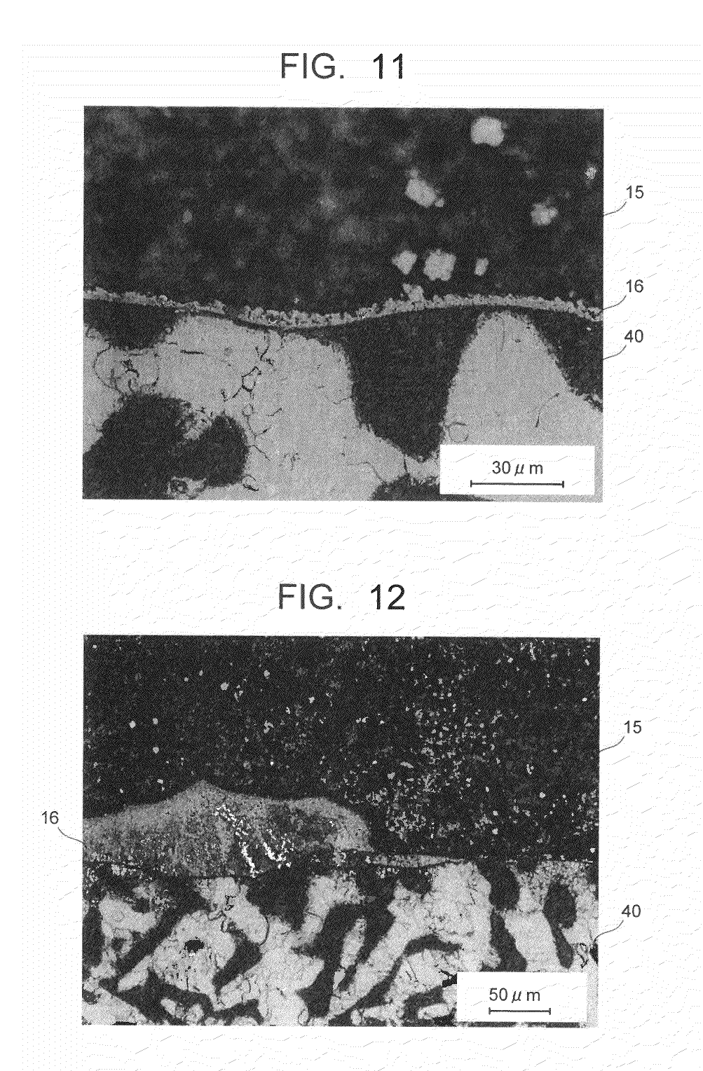

Here, FIG. 11 is a picture of observing a cross section of the interface between the soft alloy layer 15 and the base metal 40 in example 2 with the scanning electron microscope (SEM). FIG. 12 is a picture of observing a cross section of the interface between the soft alloy layer 15 and the base metal 40 in comparative example 1 with the scanning electron microscope (SEM). It was found that the thickness (8 μm on average) of the interface reaction layer 16 formed on the interface between the soft alloy layer 15 and the base metal 40 in example 2 is sufficiently thinner as compared to the thickness (75 μm on average) of the interface reaction layer 16 formed on the interface between the soft alloy layer 15 and the base metal 40 in comparative example 1.

From the above, it became obvious that, by maintaining the welding distance constant to make the arc stable and by controlling the thickness of the interface reaction layer generated on the interface between the base metal and the soft alloy layer appropriately, the tensile strength and the adhesion strength are improved, and dispersions in strength can be suppressed.

### EXAMPLE 3

In example 3, the soft alloy layer forming apparatus 10 used in example 2 was provided with the cooling gas jetting unit 60 and the base metal cooling unit 70 as shown in FIG. 5, and this soft alloy layer forming apparatus 10 was used to form a soft alloy layer 15. Other conditions were the same as in the forming method of the soft alloy layer 15 in example 2.

Here, as the cooling gas 61 of the cooling gas jetting unit 60, an Ar gas was jetted at a flow rate of 10 L/min from an Ar gas cylinder. Further, as the base metal cooling unit 70, the nozzle provided at a position facing the arc generating unit 30 via the base metal 40 was used, and water at a temperature of 10° C. was sprayed via this nozzle on the outer peripheral face of the base metal 40. In addition, the average cooling rate of the soft alloy layer 15 at this time was about 44.1° C./sec. Further, similarly to the soft alloy layer 15 in example 1, the soft alloy layer 15 formed on the inner peripheral face 41 of the base metal 40 was formed of four layers and had a thickness of 12 mm.

Test pieces were sampled from the base metal 40 on which the soft alloy layer 15 is produced as described above, and the tensile test and the adhesion strength test were performed. Note that the shape and so on of the test pieces were the same as those in example 1. The measurement methods, the measurement conditions, and so on in the tensile test and the adhesion strength test were also the same as those in example 1. Further, a cross section of the interface between the soft alloy layer 15 and the base metal 40 was observed with the scanning electron microscope (SEM) to measure the thicknesses of the interface reaction layer 16, and the average value thereof was obtained. Further, a cross section of the soft alloy layer 15 was observed with the scanning electron microscope (SEM).

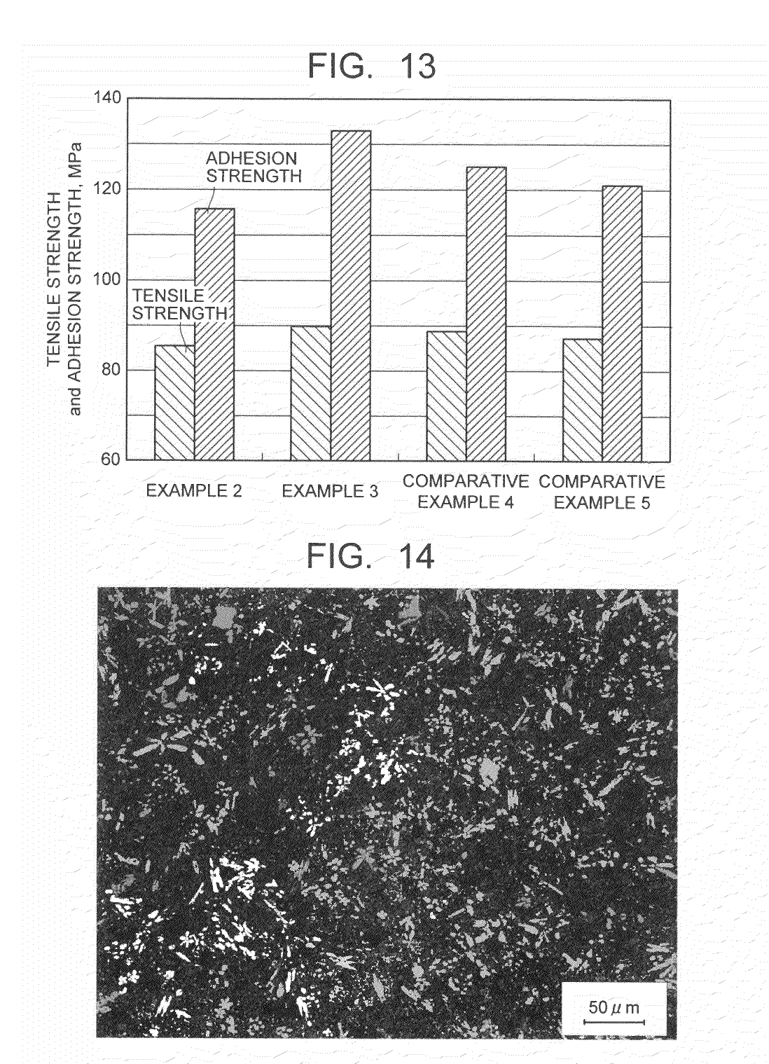

Results of the tensile test and the adhesion strength test are shown in FIG. 13. Further, the thickness of the interface reaction layer 16 was 5 μm on average. FIG. 14 is a picture of observing a cross section of the soft alloy layer 15 with the scanning electron microscope (SEM).

### EXAMPLE 4

In example 4, the base metal cooling unit 70 of the soft alloy layer forming apparatus 10 used in example 3 was removed, and this soft alloy layer forming apparatus 10 having only the cooling gas jetting unit 60 was used to form a soft alloy layer 15. Other conditions were the same as in the forming method of the soft alloy layer 15 in example 3.

Here, as the cooling gas 61 of the cooling gas jetting unit 60, an Ar gas was jetted at a flow rate of 10 L/min from an Ar gas cylinder. In addition, the average cooling rate of the soft alloy layer 15 at this time was about 39.4° C./sec. Further, similarly to the soft alloy layer 15 in example 1, the soft alloy layer 15 formed on the inner peripheral face 41 of the base metal 40 was formed of four layers and had a thickness of 12 mm.

Test pieces were sampled from the base metal 40 on which the soft alloy layer 15 is produced as described above, and the tensile test and the adhesion strength test were performed. Note that the shape and so on of the test pieces were the same as those in example 1. The measurement methods, the measurement conditions, and so on in the tensile test and the adhesion strength test were also the same as those in example 1. Further, a cross section of the interface between the soft alloy layer 15 and the base metal 40 was observed with the scanning electron microscope (SEM) to measure the thicknesses of the interface reaction layer 16, and the average value thereof was obtained. Further, a cross section of the soft alloy layer 15 was observed with the scanning electron microscope (SEM).

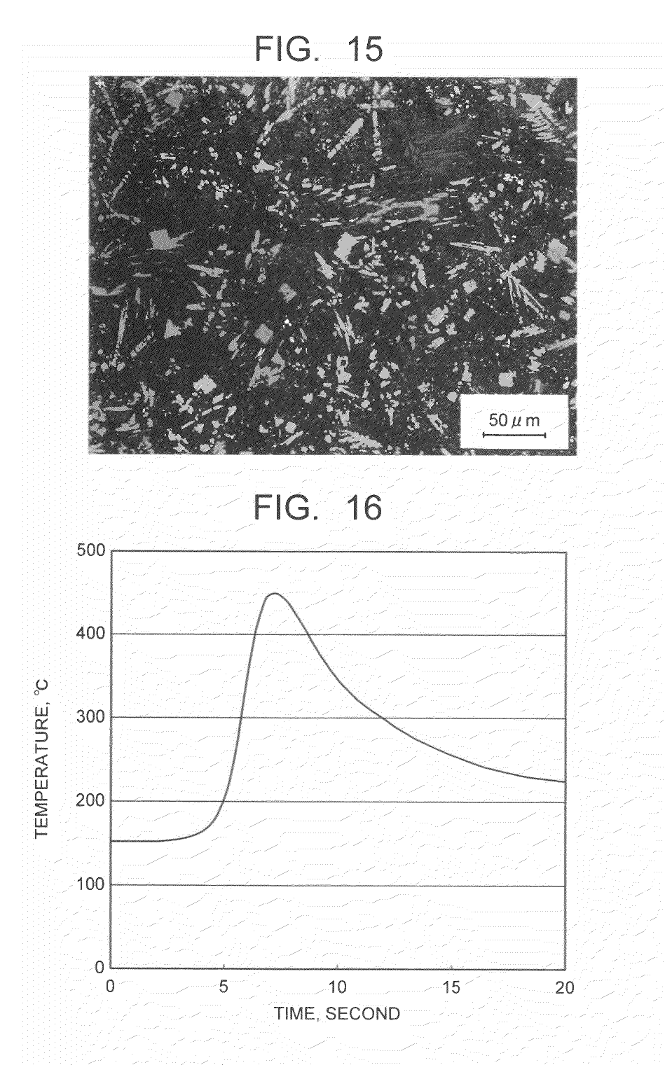

Results of the tensile test and the adhesion strength test are shown in FIG. 13. Further, the thickness of the interface reaction layer 16 was 6 μm on average. FIG. 15 is a picture of observing a cross section of the soft alloy layer 15 with the scanning electron microscope (SEM).

### EXAMPLE 5

In example 5, the cooling gas jetting unit 60 of the soft alloy layer forming apparatus 10 used in example 3 was removed, and this soft alloy layer forming apparatus 10 having only the base metal cooling unit 70 was used to form a soft alloy layer 15. Other conditions were the same as in the forming method of the soft alloy layer 15 in example 3.

Here, as the base metal cooling unit 70, the water cooled jacket 71 disposed in contact with a lower half of the outer peripheral face of the base metal 40 as shown in FIG. 5 was used. Cooling water at a temperature of 10° C. was supplied to the water cooled jacket. Here, FIG. 16 shows a change over time of the average value of temperature changes of the soft alloy layer 15. The average cooling rate of the soft alloy layer 15 at this time was about 31.7° C./sec. This average cooling rate is the speed of cooling down from the highest temperature of the soft alloy layer 15 (450° C,) to a temperature which is equal to or lower than the solidification start temperature of the material forming the soft alloy layer 15 (300° C.). Further, similarly to the soft alloy layer 15 in example 1, the soft alloy layer 15 formed on the inner peripheral face 41 of the base metal 40 was formed of four layers and had a thickness of 12 mm.

Test pieces were sampled from the base metal 40 on which the soft alloy layer 15 is produced as described above, and the tensile test and the adhesion strength test were performed. Note that the shape and so on of the test pieces were the same as those in example 1. The measurement methods, the measurement conditions, and so on in the tensile test and the adhesion strength test were also the same as those in example 1. Further, a cross section of the interface between the soft alloy layer 15 and the base metal 40 was observed with the scanning electron microscope (SEM) to measure the thicknesses of the interface reaction layer 16, and the average value thereof was obtained. Further, a cross section of the soft alloy layer 15 was observed with the scanning electron microscope (SEM).

Results of the tensile test and the adhesion strength test are shown in FIG. 13. Further, the thickness of the interface reaction layer 16 was 8 μm on average. FIG. 17 is a picture of observing a cross section of the soft alloy layer 15 with the scanning electron microscope (SEM).

### (Summary of Example 2 to Example 5)

FIG. 13 shows results of the tensile test and the adhesion strength test in example 2 having no cooling means, such as the cooling gas jetting unit 60 and the base metal cooling unit 70, in addition to results of the tensile tests and the adhesion strength tests in example 3 to example 5.

As shown in FIG. 13, it was found that even under the same build-up welding conditions, the soft alloy layers 15 in example 3 to example 5 in which the base metal 40 and the soft alloy layer 15 were forcibly cooled had more improvements in both tensile strength and adhesion strength, as compared to the soft alloy layer 15 in example 2 in which the base metal 40 and the soft alloy layer 15 were not forcibly cooled. Further, this effect was higher in order of example 3, example 4, and example 5, and the higher the degree of forcible cooling, that is, the average cooling rate in the soft alloy layer 15, the higher this effect was. In addition, the average cooling rate in example 5 with the lowest average cooling rate among example 3, example 4, and example 5 was approximately 31.7° C./sec.

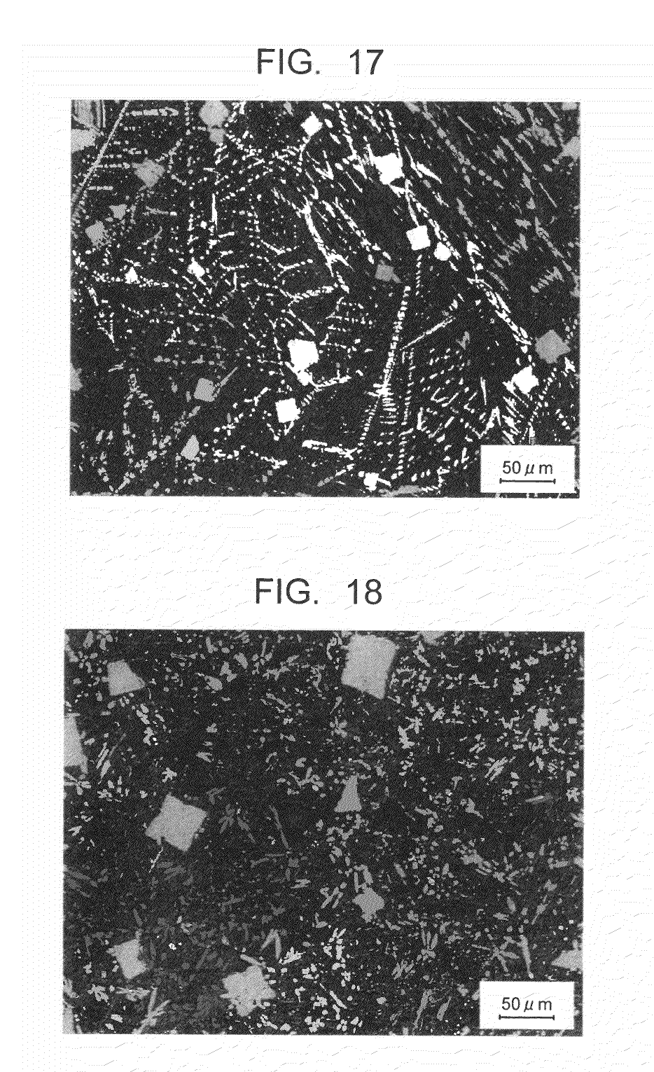

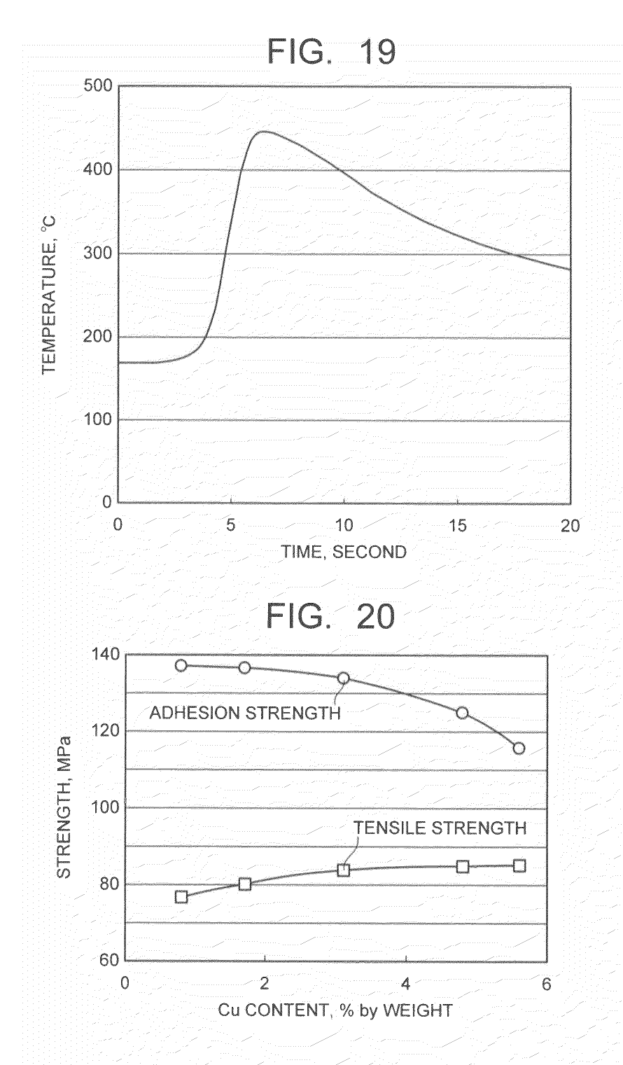

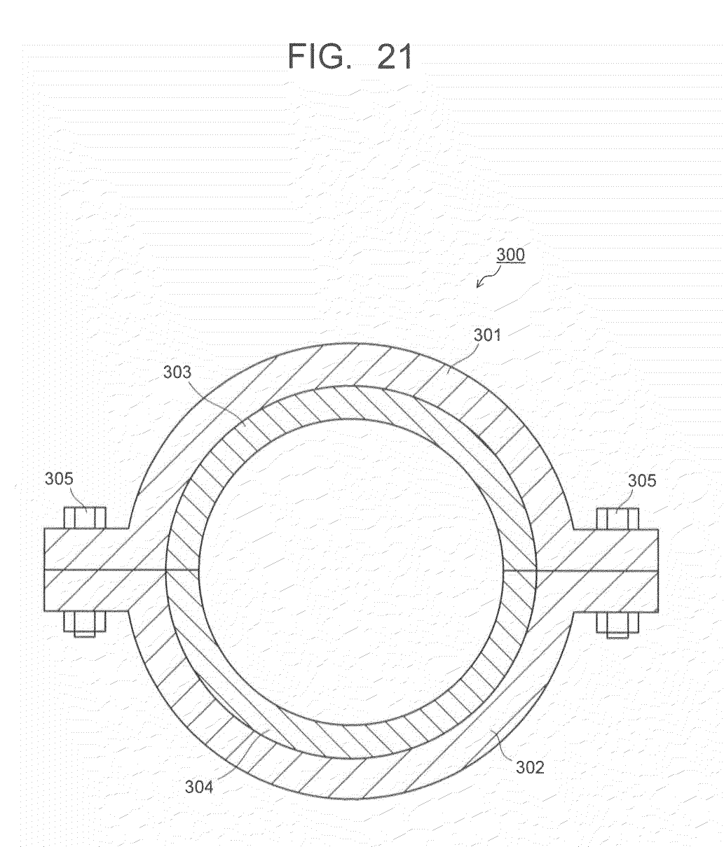

Conceivable reasons for this are that, by forcibly cooling the soft alloy layer 15 from the outside, the soft alloy layer 15 in a molten state is rapidly solidified to refine crystal grains and precipitation layers, and moreover, growth of the interface reaction layer 16 and growth of the Cu segregation layer formed on the interface between the base metal 40 and the soft alloy layer 15 are suppressed. Here, from comparison of the pictures of observing the cross sections of the soft alloy layers 15 with the scanning electron microscope (SEM) shown in FIG. 14, FIG. 15 and FIG. 17, it is clear that the crystal grains and the precipitation layers are refined in order of degree of forcible cooling, that is, in order of higher average cooling rates of the soft alloy layer 15 of example 3, example 4, and example 5. Further, FIG. 18 is a picture of observing a cross section of the soft alloy layer 15 in example 2 having no cooling unit, such as the cooling gas jetting unit 60 and the base metal cooling unit 70, with the scanning electron microscope (SEM). As shown in FIG. 18, it is clear that the soft alloy layer 15 in example 2 having no cooling unit, such as the cooling gas jetting unit 60 and the base metal cooling unit 70, has larger crystal grains and a larger precipitation layer than those in the soft alloy layer 15 in example 3 to example 5 having cooling units of the cooling gas jetting unit 60 and the base metal cooling unit 70. Here, FIG. 19 shows a change over time of the average value of temperature changes of the soft alloy layer 15 in example 2. The average cooling rate of the soft alloy layer 15 at this time was about 11.4° C./sec. This average cooling rate is the speed of cooling down from the highest temperature of the soft alloy layer 15 (450° C.) to the solidification start temperature of the material forming the soft alloy layer 15 (300° C.).

### (Interface Reaction Layer 16)

When the interface reaction layer 16 constituted mainly of Fe, Sn, and Sb and formed on the interface between the base metal 40 and the soft alloy layer 15 is too thin, the adhesion strength thereof decreases. Meanwhile, when it is too thick, a Cu segregation layer is formed on the interface between the interface reaction layer 16 and the soft alloy layer 15, and the adhesion strength thereof decreases. Therefore, it is preferable that the interface reaction layer 16 is formed with a predetermined thickness evenly on the interface between the base metal 40 and the soft alloy layer 15.

From the measurement results of the interface reaction layers 16 in above-described example 1 to example 5, it was found that the interface reaction layer 16 is formed almost evenly on the interface between the base metal 40 and the soft alloy layer 15 when the average thickness of the interface reaction layers 16 is 5 μm or larger. On the other hand, the aforementioned Cu segregation layer tends to stand out when the average thickness of the interface reaction layer 16 exceeds 20 μm. Therefore, by selecting build-up welding conditions so that the average thickness of the interface reaction layer 16 becomes 5 μm to 20 μm, the soft alloy layer 15 with excellent adhesion strength can be formed.

### (Cu Content in the Interface Reaction Layer 16)

Here, the Cu content in the soft alloy member 50 was changed, the interface reaction layer 16 was formed by the same method as the forming method of the interface reaction layer 16 in example 2, and tensile strength and adhesion strength thereof were measured. Here, as the soft alloy member 50, a white metal 2nd class (WJ2) was used as a base material and the Cu content was changed.

Test pieces were sampled from the base metals 40 on which the soft alloy layers 15 with different Cu contents are produced, and tensile tests and adhesion strength tests were performed. Note that the shapes and so on of the test pieces were the same as those in example 1. The measurement methods, the measurement conditions, and so on in the tensile test and the adhesion strength test were also the same as those in example 1. Results of the tensile test and the adhesion strength test are shown in FIG. 20.

It was found that, as shown in FIG. 20, in the range of these tests, the tensile strength of the soft alloy layer 15 exhibits a tendency to gradually decrease and meanwhile the adhesion strength exhibits a tendency to increase, along with decreasing of the Cu content. Conceivable reasons for this are that the tensile strength decreases because the volume ratio of the precipitation layer mainly constituted of Cu in the soft alloy layer 15 decreases due to decrease of the Cu content, and the adhesion strength increases because generation of the Cu segregation layer is suppressed along with generating of the interface reaction layer 16 formed on the interface between the base metal 40 and the soft alloy layer 15.

When the Cu content is 1% to 5% by weight as shown in FIG. 20, it has sufficient tensile strength and adhesion strength as the soft alloy layer 15. Further, from these results, it is preferable that the Cu content in the first layer of the soft alloy layer 15 directly affecting the adhesion strength is 1% to 5% by weight. For improvement in tensile strength, it is preferable that the second layer and subsequent layers has a higher Cu content than the first layer. Here, there is a possibility that part of the first layer is melted again when the second layer is build-up welded and the Cu amount in the second layer decreases, and thus it is further preferable that the Cu content of the first layer is 3% to 5% by weight.

The present invention has been described specifically above by the embodiments, but the present invention is not limited to these embodiments and can be changed in various ways without departing from the spirit thereof.

What is claimed is:

1. A soft alloy layer forming apparatus forming a soft alloy layer, constituted of a soft alloy and slidably contacting a rotor, on an inner peripheral face of a base metal that is an arc face by build-up welding process, the apparatus, comprising:
a base metal support part rotationally supporting the base metal with a center axis of an inner periphery of the base metal being a rotation axis; and
an arc generating unit movable in an axial direction of the rotation axis, fixed at a predetermined distance from the inner peripheral face of the base metal, and generating an arc between itself and the base metal,
wherein while rotating the base metal by the base metal support part and maintaining the predetermined distance constant between the arc generating unit and the inner peripheral face of the base metal, a soft alloy member constituted of a soft alloy is melted by the arc generated by the arc generating unit to thereby form a soft alloy layer on the inner peripheral face of the base metal.

2. The soft alloy layer forming apparatus according to claim 1, further comprising,
a cooling gas jetting unit jetting a cooling gas to the soft alloy layer.

3. The soft alloy layer forming apparatus according to claim 1, further comprising,
a base metal cooling unit cooling an outer peripheral face of the base metal.

4. A soft alloy layer forming method of forming a soft alloy layer, constituted of a soft alloy and slidably contacting a rotor, on an inner peripheral face of a base metal that is an arc face by build-up welding process, the method, comprising:
rotationally supporting the base metal with a center axis of an inner periphery of the base metal being a rotation axis; and
while rotating the base metal and maintaining a predetermined distance constant between an arc generating unit movable in an axial direction of the rotation axis and the inner peripheral face of the base metal, forming a soft alloy layer on the inner peripheral face of the base metal by melting a soft alloy member constituted of a soft alloy by an arc generated between the arc generating unit and the base metal.

5. The soft alloy layer forming method according to claim 4,
wherein in the forming of the soft alloy layer, a welding current for forming a second soft alloy layer and subsequent soft alloy layers formed on a first soft alloy layer is smaller than a welding current for forming the first soft alloy layer on the inner peripheral face of the base metal.

6. The soft alloy layer forming method according to claim 4,
wherein the soft alloy member is formed of an alloy constituted mainly of tin (Sn) containing copper (Cu) and antimony (Sb), and a copper content for forming a first soft alloy layer on the inner peripheral face of the base metal is smaller than a copper content for forming a second soft alloy layer and subsequent soft alloy layers formed on the first soft alloy layer.

7. The soft alloy layer forming method according to claim 6,
wherein the copper content for forming the first soft alloy layer is 1% to 5% by weight.

8. The soft alloy layer forming method according to claim 4,
wherein in the forming of the soft alloy layer, a cooling gas is jetted to the soft alloy layer.

9. The soft alloy layer forming method according to claim 4,
wherein in the forming of the soft alloy layer, an outer peripheral face of the base metal is cooled.

10. The soft alloy layer forming method according to claim 4,
wherein an average thickness of an interface reaction layer formed on an interface between the base metal and the soft alloy layer is 5 μm to 20 μm.
